(19) United States
(12) Patent Application Publication
(10) Pub. No.: US 2017/0355306 A1
(43) Pub. Date: Dec. 14, 2017

(54) Vehicle-Mounted External Display System

(71) Applicant: Leo Burnett Company, Inc., Chicago, IL (US)

(72) Inventors: Fernando Bellotti, Buenos Aires Province (AR); D'Amelio Luciano Emmanuel, Buenos Aires City (AR); Maselli Chritian Dario, Buenos Aires City (AR); Luis Maria Sanchez Zinny, Buenos Aires City (AR)

(21) Appl. No.: 15/176,637

(22) Filed: Jun. 8, 2016

(51) Int. Cl. B60R 1/00; G08G 1/09; G08G 1/16

(52) U.S. Cl. CPC B60R 1/00; G08G 1/167; G08G 1/094; B60R 2300/307; B60R 2300/301; B60R 2300/202

(57) ABSTRACT

A terrestrial vehicle such as a truck has one or more video cameras mounted to capture a field of view that includes looking forward and ahead of the vehicle. The vehicle also includes one or more rear-mounted, rear-facing displays that are operably coupled to such a camera. Forward-looking images from the front side of the vehicle are presented on the aforementioned displays to thereby provide a viewer positioned behind the vehicle with that forward-looking image of the road ahead. So configured, drivers looking to pass such a vehicle are provided with real-time information regarding circumstances that can greatly affect the safety of such an action and can use that information to better inform their decisions and actions.

### TECHNICAL FIELD

These teachings relate generally to terrestrial vehicles.

### BACKGROUND

Terrestrial vehicles of various kinds are known in the art. Many such vehicles, including trucks of various kinds, generally ply public roads. Such roads are often parsed into one or more lanes and many times accommodate two-way traffic.

In a typical application setting not all vehicles on such a road proceeding in a same direction are traveling at an identical speed. As a result, faster-moving vehicles from time to time will pass slower-moving vehicles. In some instances passing a slower-moving vehicle will require the faster-moving vehicle to temporarily occupy a traffic lane primarily intended for vehicles moving in the opposite direction. Accordingly, passing in this way is best done when the driver of the passing vehicle is well informed of the presence or absence of oncoming traffic.

Many trucks, due in considerable part to their relative size and weight, tend to comprise a slower-moving part of traffic. In some jurisdictions trucks are in fact required to observe a lower speed limit than other vehicles such as automobiles. As a result, it is not uncommon that the slower-moving vehicle that a faster-moving vehicle wishes to pass will comprise a truck. Unfortunately, as already noted, trucks are often relatively large. As a result the truck itself can at least partially if not fully occlude a good view of the road ahead. Those overall circumstances, in further combination with the length of the truck that must be passed, often lead to passing situations where the driver of the passing vehicle lacks good information about oncoming traffic or other circumstances relevant to their passing decisions.

### BRIEF DESCRIPTION OF THE DRAWINGS

The above needs are at least partially met through provision of the vehicle-mounted external display system described in the following detailed description, particularly when studied in conjunction with the drawings, wherein:

FIG. 1 comprises a block diagram as configured in accordance with various embodiments of these teachings;

FIG. 2 comprises a rear elevational schematic view as configured in accordance with various embodiments of these teachings;

FIG. 3 comprises a rear elevational schematic view as configured in accordance with various embodiments of these teachings;

FIG. 4 comprises a rear perspective view as configured in accordance with various embodiments of these teachings;

FIG. 5 comprises a rear perspective view as configured in accordance with various embodiments of these teachings;

FIG. 6 comprises a rear perspective view as configured in accordance with various embodiments of these teachings;

FIG. 7 comprises a screenshot as configured in accordance with various embodiments of these teachings;

FIG. 8 comprises a screenshot as configured in accordance with various embodiments of these teachings;

FIG. 9 comprises a screenshot as configured in accordance with various embodiments of these teachings; and

FIG. 10 comprises a block diagram view as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a terrestrial vehicle such as a truck has one or more video cameras mounted to capture a field of view that includes looking forward and ahead of the vehicle. The vehicle also includes one or more rear-mounted, rear-facing displays that are operably coupled to such a camera. So configured, forward-looking images from the front side of the vehicle are presented on the aforementioned displays to thereby provide a viewer positioned behind the vehicle with that forward-looking image of the road ahead. To some substantial degree, that viewer is now effectively looking through the truck. So configured, drivers looking to pass such a vehicle are provided with real-time information regarding circumstances that can greatly affect the safety of such an action and can use that information to better inform their decisions and actions.

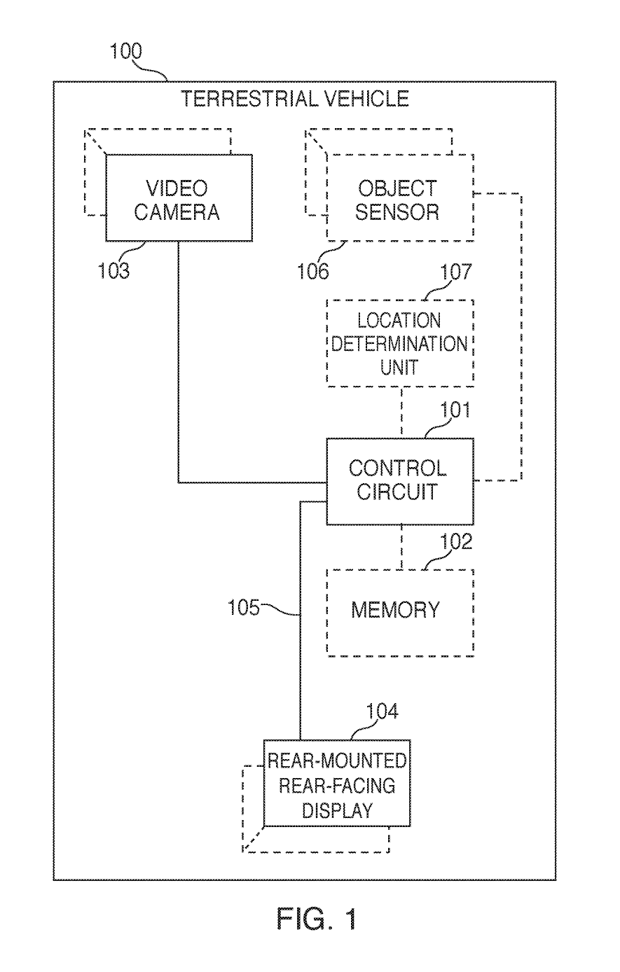

These and other benefits may become clearer upon making a thorough review and study of the following detailed description. Referring now to the drawings, and in particular to FIG. 1, an illustrative vehicle that is compatible with many of these teachings will now be presented.

FIG. 1 presents a terrestrial vehicle 100 that comprises for the sake of an illustrative example a truck. As used herein, a truck will be understood to comprise a vehicle configured to primarily carry cargo as versus passengers. It will also be understood that, as used herein, a truck can comprise a single vehicle (where the cargo-containing area and the driver's cabin and means of locomotion are all rigidly co-joined) or a truck can comprise two or more coupled vehicles (where, for example, a first vehicle comprises the driver's cabin and drivetrain components and where a second vehicle comprises a cargo-containing trailer that is connected to and towed by the first vehicle).

Generally speaking, the present teachings become increasingly more beneficial as the size of the truck (or at least as the size of the cargo-containing area) increases (especially in terms of the cross-sectional dimensions of the truck).

In this illustrative example the terrestrial vehicle 100 includes a control circuit 101 that may optionally operably coupled to a corresponding memory 102. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

The memory 102 may be integral to the control circuit 101 or can be physically discrete (in whole or in part) from the control circuit 101 as desired. This memory 102 can serve, for example, to non-transitorily store the computer instructions that, when executed by the control circuit 101, cause the control circuit 111 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

The control circuit 101 also operably couples to one or more video cameras 103. By one approach the control circuit 101 comprises an integral part of such a video camera if desired. This one or more video camera 103 is mounted in order to capture a field of view that includes at least in part a forward-looking view from the front of the terrestrial vehicle 100. Accordingly, such a video camera 103 may be mounted on a front surface of the terrestrial vehicle 100 and/or within the driver's cabin with a view out the front windshield. Other mounting locations and configurations are possible.

This video camera 103 may be full-color, monochromatic, or otherwise as desired and can be wireless or non-wireless as desired. For most application settings it will likely be beneficial that the video camera 103 constitute a digital device that provides its image output as a digital representation of the captured field of view. These teachings will also accommodate using a video camera 103 that captures images using other than visible light. For example, the video camera 103 may comprise an infrared camera. Such a camera can be useful, for example, when capturing images in a darkened setting.

The video imagery from the video camera 103 is provided by the control circuit 101 to a rear-mounted, rear-facing display 104. That datalink 105 can be partially or wholly wireless or non-wireless as desired. Numerous approaches to communicating video data are known in the art. As the present teachings are not particularly sensitive to any specific choices in these regards, further elaboration regarding this datalink 105 is not provided here for the sake of brevity.

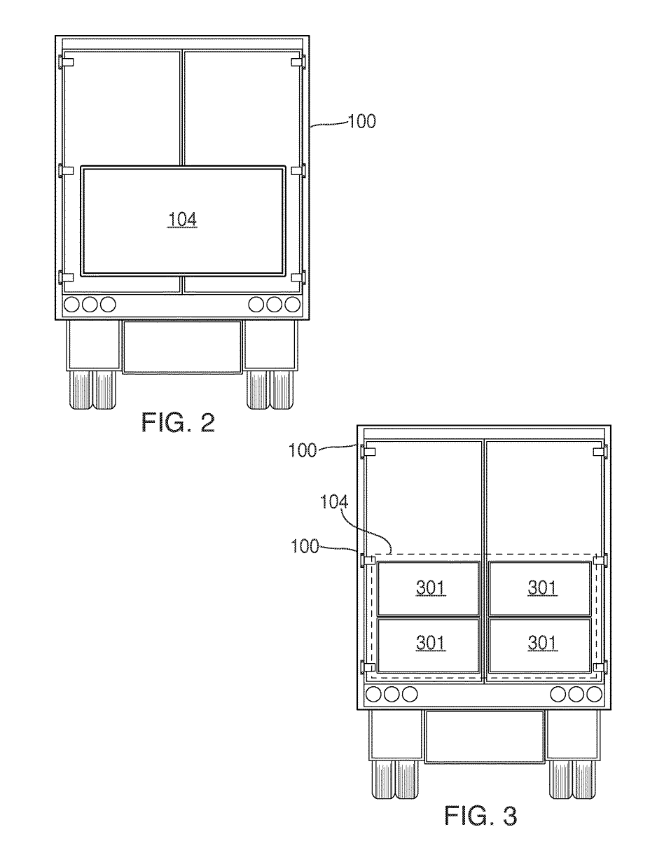

Referring momentarily to FIG. 2, in some application settings it may be appropriate for the display to comprise a single display that is mounted on the backside of the terrestrial vehicle 100. Such a configuration can be appropriate, for example, when the backside of the terrestrial vehicle 100 lacks any doors or other points of ingress to the cargo-containing area of the terrestrial vehicle 100.

By another approach, and referring momentarily to FIG. 3, in other application settings it may be appropriate for the display 104 to comprise a plurality of displays 301 that each present a part of an overall composite video image. In this particular illustrative example, the backside of the terrestrial vehicle 100 comprises two side-by-side doors 302 that pivot on their outer edges to thereby provide access to the cargo-containing area of the terrestrial vehicle 100. By using multiple displays 301 as described the rear-mounted, rear-facing display 104 does not interfere with or otherwise block that pivoting capability of these doors 302.

There may be other reasons for forming the rear-mounted, rear-facing display 104 from a plurality of individual displays that together form a single image corresponding to the forward-looking view being provided by the video camera 103. This approach, for example, may free the designer from limitations driven by the aspect ratio that is otherwise inherent to any individual display.

Referring still to FIG. 1, these teachings will accommodate optionally including one or more object sensors 106 that operably couple to the control circuit 101. Possibly useful examples in these regards include automotive radar units, ultrasonic ranging devices, and so forth. Such object sensors 106 can provide information about objects ahead of the terrestrial vehicle 100 that may otherwise be hard to discern in the imagery being captured and provided by the video camera 103. For example, an appropriate object sensor 106 may provide information regarding an oncoming vehicle that is approaching in inclement weather that visually occludes or masks the presence and approach of that oncoming vehicle. By one approach such sensor information can be merged or otherwise combined with the video imagery being provided by the video camera 103 in order to provide a composite, aggregated view in these regards via the rear-mounted, rear-facing display 104.

These teachings will also accommodate optionally including a location determination unit 107 that operably couples to the control circuit 101. For example, a Global Positioning System (GPS) receiver can serve as a location determination unit and provide to the control circuit 101 information regarding a present location of the terrestrial vehicle 100. That location information, in turn, may be leveraged by the control circuit 101 to glean additional information regarding the path ahead of the terrestrial vehicle 100. For example, using the location of the terrestrial vehicle 100 the control circuit 101 can access one or more map databases to obtain information regarding upcoming turns, hills, or other pathway features that the control circuit 101 may then add to the imagery being provided via the rear-mounted, rear-facing display 104.

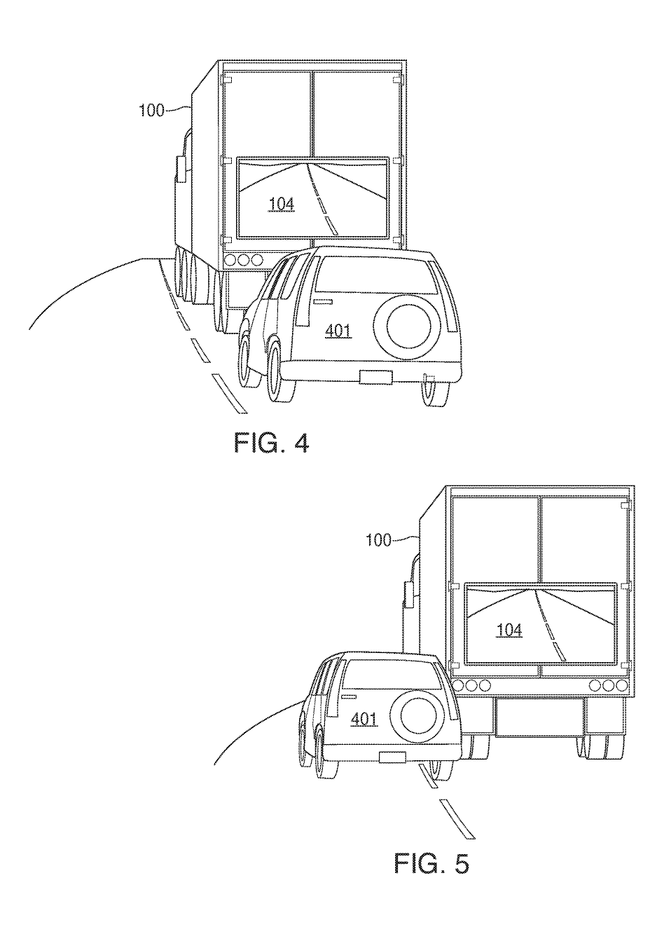

FIGS. 4 and 5 illustrate such a terrestrial vehicle 100 during use. In FIG. 4 a passenger car 401 is trailing a terrestrial vehicle 100 configured as described above. In this example the rear-mounted, rear-facing display 104 comprises four separate displays that present, in combination, a composite forward-looking view in front of the terrestrial vehicle 100. As shown in FIG. 5, the driver of the passenger car 401 can readily ascertain that the terrestrial vehicle 100 could be likely safely passed at the present time. In particular, the driver of the passenger car 401 could readily discern from the video image presented on the rear-mounted, rear-facing display 104 that there was no oncoming traffic in the lane that the passenger car 401 must necessarily use to pass the terrestrial vehicle 100.

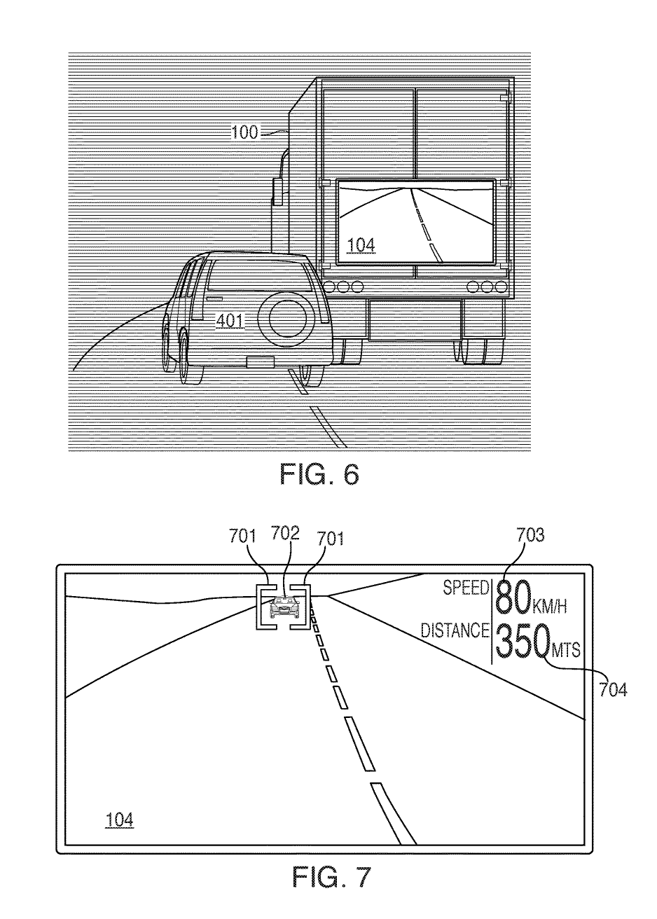

FIG. 6 illustrates a similar example and scenario where the rear-mounted, rear-facing display 104 provides a night-time relevant view.

So configured, neither the driver of the terrestrial vehicle 100 nor any on-board components or systems need actively monitor the pathway ahead nor analyze the pathway ahead for passing concerns. Instead, the view ahead as provided to a trailing driver is inherently sufficient in many cases to permit even a driver unfamiliar with this paradigm to determine for themselves when it may be sufficiently safe to pass the terrestrial vehicle 100.

If desired, these teachings will accommodate embellishing the image provided on the rear-facing display 104 with additional information to thereby provide an augmented reality view. For example, the image may be augmented to artificially highlight the presence and location of an oncoming vehicle.

FIG. 7 provides one example in these regards. In this example the captured video image of the road ahead also features a pair of brackets 701 overlaid thereon on either side of an oncoming vehicle 702 to indicate the presence and location of that oncoming vehicle 702 in the distance. Those brackets 701 can be colored to help the viewer quickly discern the presence and location of the brackets 701 and may comprise, for example, bright yellow-colored brackets.

By another approach the highlighting feature (in this case, the brackets 701) can be animated in some fashion to further help attract the eye of the viewer. For example, the brackets 701 could blink on and off at some regular interval such as every half second or could move/grown outwardly for a short period of time and then move/shrink inwardly to again more tightly encompass the oncoming vehicle. It would also be possible to change the featured color (for example, from yellow to red to white in a repeated cycle) if desired. The person of ordinary skill in the art will understand that these teachings will readily accommodate other approaches to attract the attention of the viewer as desired.

Information from the aforementioned object sensor 106 can serve to detect that oncoming vehicle 702 and to help properly position those brackets 701. Using another approach the control circuit 101 could be configured to recognize, in real time or near real time, an oncoming vehicle in such an image using, for example, pattern matching methodologies.

In the example just provided the oncoming vehicle 702 is visible in the captured image but is relatively small and may therefore be difficult for a following driver to quickly and/or easily discern. The described brackets 701 can help that following driver to be aware of that oncoming vehicle 702 notwithstanding the present difficulty in seeing the vehicle itself.

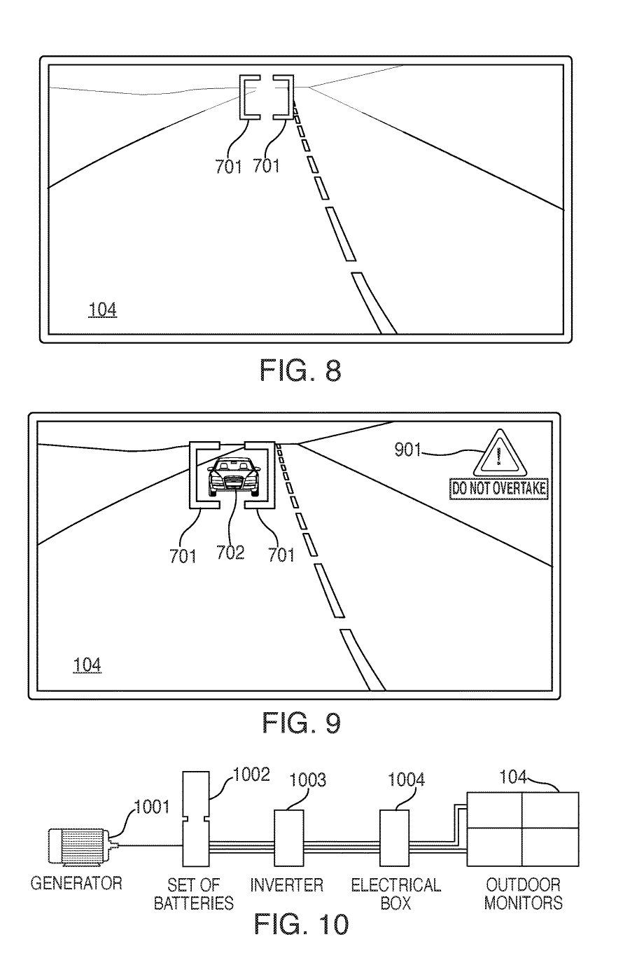

With reference to FIG. 8, those brackets 701 can also serve to indicate the location and presence of an oncoming vehicle 702 even when the oncoming vehicle 702 is difficult or impossible to visually identify in the visual imagery. Such circumstances can arise, for example, due to fog, smoke, twilight or darkness, and so forth.

With reference again to FIG. 7, these teachings will also accommodate simultaneously displaying one or more items of metadata as pertain to the oncoming vehicle 702. In this illustrative example the metadata includes the detected speed 703 of the oncoming vehicle 702 and its current distance 704 (from, for example, the front of the truck or the back of the truck). Such information can be helpful to a following driver when assessing the safety of attempting to pass the vehicle 100 at the present time. Other metadata that could be provided, if desired, includes current speed limit information, warnings that the speed limit or other road conditions (such as the number of lanes, no passing zones, and so forth) are about to change (for example, within some specified distance such as 300 feet, one half mile, and so forth (where such information can be gleaned, for example, using present location information and map information).

By one approach the aforementioned control circuit 101 can be configured to take the oncoming vehicle's speed and distance (and any other factors that might be appropriate in a given application setting) into account and automatically determine whether it may be presently unsafe for the following driver to attempt to pass the vehicle 100. Upon determining that conditions are unsafe to pass, and referring to FIG. 9, the display 104 can convey that safety concern in any of a variety of ways. In this particular example the aforementioned brackets 701 on either side of the oncoming vehicle 702 can be colored a different color, such as red, to convey a heightened sense of concern. In this example the display 104 also now includes an explicit warning 901 to caution the following driver to not attempt to pass the vehicle 100 at the present time.

In a typical application setting the aforementioned displays 104 will be powered by electricity supplied by the vehicle 100 itself. As one illustrative example in these regards, and referring now to FIG. 10, an on-board generator (or alternator as the case may be) 1001 produces electricity and that electricity charges on-board batteries 1002. Those batteries 1002 provide DC power to an inverter 1003 that converts the DC power to AC power. An electrical box 1004 then controls the distribution of that AC power in a way that includes the aforementioned display 104.

So configured, even very large trucks (including multi-trailer so-called road trains) can be more safely passed by providing the passing driver with important information that may be impossible to have without increased risk to the passing driver and that can help inform their decisions regarding at least one driving maneuver (such as passing the truck).

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A terrestrial vehicle having at least one forward-looking video camera that operably couples to at least one rear-mounted, rear-facing display such that a real-time display of forward-looking imagery that would otherwise be unavailable to a driver following the terrestrial vehicle is provided to the driver to help inform their decisions regarding at least one driving maneuver, wherein the real-time display further includes at least one added visual informational element that augments the display of forward-looking imagery.

2. The terrestrial vehicle of claim 1 wherein the terrestrial vehicle comprises a truck.

3. The terrestrial vehicle of claim 1 wherein the at least one added visual information element artificially highlights at least one oncoming vehicle.

4. The terrestrial vehicle of claim 3 wherein the visual information element comprises a pair of brackets.

5. The terrestrial vehicle of claim 4 wherein the pair of brackets are positioned on the real-time display such that the oncoming vehicle is disposed within the pair of brackets.

6. The terrestrial vehicle of claim 3 wherein the visual information element is at least partially animated to thereby further attract a viewer's attention.

7. The terrestrial vehicle of claim 3 wherein the at least one added visual information element further comprises at least one item of metadata regarding at least one of the oncoming vehicle and upcoming roadway conditions.

8. The terrestrial vehicle of claim 7 wherein the at least one item of metadata comprises a speed of the oncoming vehicle.

9. The terrestrial vehicle of claim 7 wherein the at least one item of metadata comprises a current distance of the oncoming vehicle.

10. The terrestrial vehicle of claim 3 wherein the at least one added visual information element further comprises an automatically-determined warning to caution a viewer to not presently attempt to pass the terrestrial vehicle.

11. A method for use with a terrestrial vehicle having at least one forward-looking video camera that operably couples to at least one rear-mounted, rear-facing display, the method comprising:
using images provided by the at least one forward-looking video camera to present on the at least one rear-mounted, rear-facing display a real-time display of forward-looking imagery that would otherwise be unavailable to a driver following the terrestrial vehicle to help inform their decisions regarding at least one driving maneuver, wherein the real-time display further includes at least one added visual informational element that augments the display of forward-looking imagery.

12. The method of claim 11 wherein the terrestrial vehicle comprises a truck.

13. The method of claim 11 wherein the at least one added visual information element artificially highlights at least one oncoming vehicle.

14. The method of claim 13 wherein the visual information element comprises a pair of brackets.

15. The method of claim 14 wherein the pair of brackets are positioned on the real-time display such that the oncoming vehicle is disposed within the pair of brackets.

16. The method of claim 13 wherein the visual information element is at least partially animated to thereby further attract a viewer's attention.

17. The method of claim 13 wherein the at least one added visual information element further comprises at least one item of metadata regarding at least one of the oncoming vehicle and upcoming roadway conditions.

18. The method of claim 17 wherein the at least one item of metadata comprises a speed of the oncoming vehicle.

19. The method of claim 17 wherein the at least one item of metadata comprises a current distance of the oncoming vehicle.

20. The method of claim 13 wherein the at least one added visual information element further comprises an automatically-determined warning to caution a viewer to not presently attempt to pass the terrestrial vehicle.
